(19) United States
(12) Patent Application Publication
(10) Pub. No.: US 2005/0181164 A1
(43) Pub. Date: Aug. 18, 2005

(54) Grip tape

(76) Inventors: Timothy Piumarta, Soquel, CA (US); Jeremy Fox, Huntington Beach, CA (US)

Correspondence Address: KOLISCH HARTWELL, P.C., 520 S.W. YAMHILL STREET, SUITE 200, PORTLAND, OR, 97204, US

(21) Appl. No.: 10/780,918

(22) Filed: Feb. 17, 2004

(51) Int. Cl. B32B 9/00

(52) U.S. Cl. 428/40.1; 428/137; 428/143

(57) ABSTRACT

A grip tape is provided for application to a substrate without substantially entrapping air bubbles between the tape and the substrate. The tape includes a sheet of film of one or more plies, a layer of grit material fixed on one side of the sheet and an adhesive layer on the other and a plurality of perforations extending therethrough. The perforations are distributed over an area of the tape and provide openings for fluid passage therethrough that define a cumulative cross-sectional area that is no more than about 1% of the tape area over which the perforations are distributed. The perforations are sized and spaced apart to provide sufficient fluid passage therethrough to substantially prevent air bubbles from forming between the tape and the substrate.

### BACKGROUND

A floor, stair step, ladder rung, or a sporting device, such as a skateboard or scooter, and other structures and devices presenting a substrate upon which a user steps, may be improved in the friction provided to the user's foot or shoe by applying a grip tape over the substrate. The tape is typically provided with a friction-enhanced upper surface, for example, by a layer of grit that covers the upper surface of the tape.

The tape typically includes a lower surface coated with an adhesive to attach the tape to the substrate, and it is desirable that the tape adhere uniformly and conformably to the substrate. Sometimes, however, uniform and conformal adherence of the tape to the substrate is not achieved. This tends to happen particularly in the case where the substrate is not a simple flat plane, but is curved or angled in one or more directions, with either a simple linear curve or angle or a more complex shape, and where the area to be covered is relatively large, that is, several inches in width and/or length. The tape, as it is lowered onto the substrate and pressed into place, may trap air bubbles between the tape and the substrate.

At the location of each air bubble, the tape is typically not adhered to the substrate and is raised in a hemispherical shape. Such conditions, when the user's shoe is pressed onto and slided along or across the tape and/or moved rotationally with respect to the tape, tend to overcome the tensile strength of the tape in the area adjacent the bubble and to cause the tape to fail by tearing.

When the tape fails, a portion of the tape may tear completely away or become deformed to the point that the tape in that area provides no improvement in traction. The torn tape, and the air bubbles, even when not torn, create a non-uniform, undesirable surface, which in addition to the degradation in traction performance, may obscure a design, wording, or other graphic material printed on the tape. The air bubbles may be removed by popping each bubble, but this is time-consuming and may tear the tape because of the pressure of the air bubble on the tape.

### SUMMARY

A grip tape is provided that can be applied to a substrate without substantially entrapping air bubbles between the tape and the substrate. The grip tape may be made up of a sheet of film with a layer of grit material fixed on one side of the sheet and an adhesive layer on the opposite side of the sheet. The adhesive layer, grit layer, and sheet may be provided with a plurality of perforations extending therethrough. These perforations may be distributed over the area of the sheet surfaces. These perforations each define a cross-sectional area, and in combination the plurality of perforations defines a cumulative area, which typically is no more than about 1% of the sheet surface area over which the perforations are distributed.

The film sheet of the grip tape may be substantially comprised of a thermoplastic material, and may be formed with two plies for improved tensile strength. The perforations are typically regularly distributed over the tape and are spaced apart and provided with a sufficient cross-sectional area to allow sufficient fluid passage therethrough to substantially prevent the entrapping of air bubbles between the tape and the substrate.

A method for making the grip tape may include providing a length of film, applying an adhesive layer to one side of the film, applying a layer of grit to the other side of the film, and perforating the film, adhesive layer, and grit layer with a plurality of pinholes distributed over the length and width of the film. The perforation may be carried out by running the tape through rollers, using a die, or other suitable methods.

### BRIEF DESCRIPTION OF THE DRAWINGS

FIG. 1 is a cross-sectional view of a grip tape in accordance with an embodiment of the present invention, showing a grit layer, a binder layer for holding the grit to an upper surface of a film layer, and a pressure-sensitive adhesive on a lower surface of the film layer with a release paper covering the pressure-sensitive adhesive.

FIG. 2 is an overhead view of the grip tape of FIG. 1 showing a regular pattern of staggered rows of pinholes distributed over the surface area of the grip tape and showing typical dimensions of the pinholes and row layouts.

FIG. 3 is a schematic diagram of a process for forming the grip tape, including coating a roll of film on one side with an adhesive, drying the adhesive, covering the adhesive with a release paper, and rolling up the assembled tape.

FIG. 4 is a schematic diagram of a process for forming the grip tape, including coating the film on the side opposite the release paper with a binder, electrostatically applying a grit layer to the binder, drying the binder, applying an adhesive over the grit and binder, drying the adhesive over the grit and binder, and rolling up the assembled grip tape.

FIG. 5 is a schematic diagram of a process for forming the grip tape, including rolling the tape through opposed rollers, one having a distributed pattern of pinhole-making structures, and the other providing a surface against which the tape is pressed to allow the structures to perforate the tape.

FIG. 6 is a schematic diagram of a process for forming the grip tape, including positioning the tape between a board having a distributed pattern of pinhole-making structures and a plate providing a surface against which the tape is pressed to allow the structures to perforate the tape.

### DETAILED DESCRIPTION

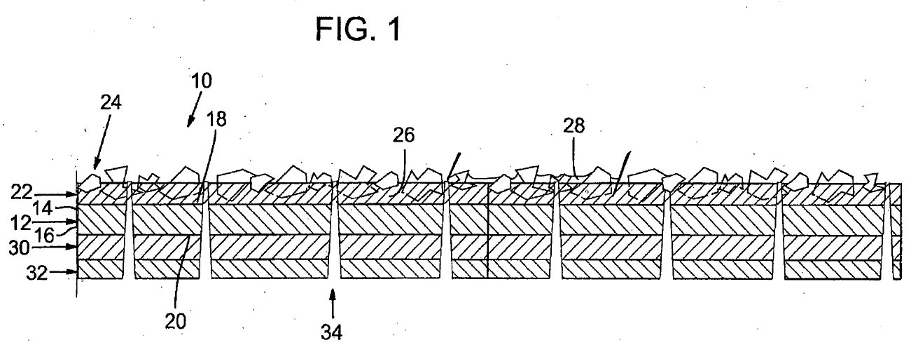

As shown in FIG. 1, a grip tape according to an embodiment of the present invention is indicated generally at 10. Tape 10 includes a film sheet 12, which may include a first ply 14 and a second ply 16, or be constructed of only a single ply depending on the tape characteristics desired. Typically the film sheet made of two or more plies will have a greater tensile strength, and thus greater resistance to tearing, than the film sheet of a single ply, particularly where the tape is perforated, as will be described below. Film sheet 12 may also include graphical material: pictures, words, logos, etc., printed therein by any suitable printing technique. Film sheet 12 typically is a thermoplastic material, for example, polyethylene, and suitable material for the film sheet is made by Valéron® Strength Films, an ITW Company, in Houston, Tex.

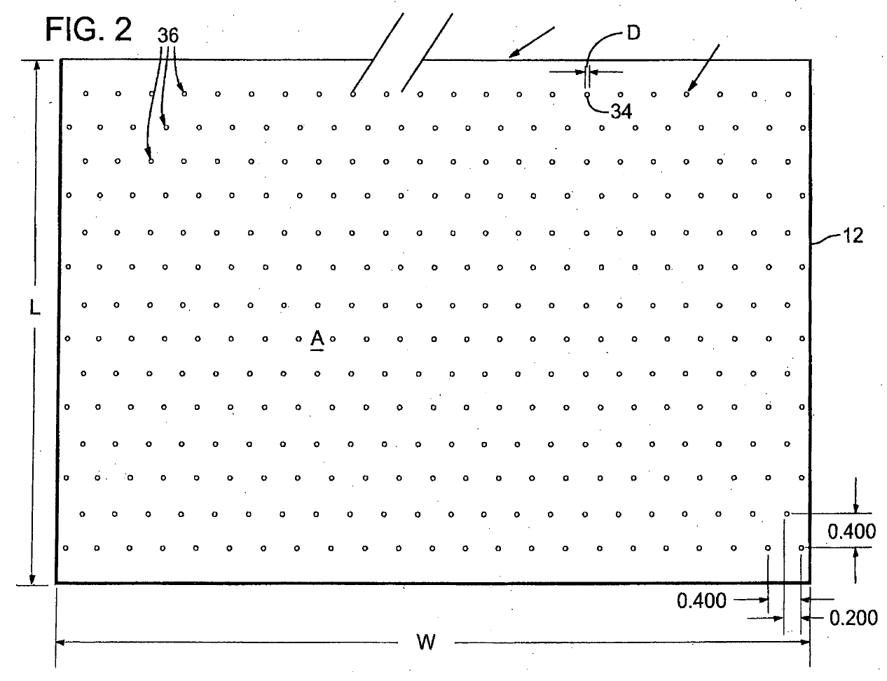

Film sheet 12 includes a first or upper surface 18 and a second or lower surface 20 opposite to and coextensive with the first surface. The surfaces have a width W and a length L defining an area A (FIG. 2). The width, length, and area may be any size, depending on the substrate to which the tape will be applied, and the area may be rectangular as shown in FIG. 2, or have any shape of a regular or irregular polygon, or curved edges. A typical width is about 9-inches and a typical length is about 33-inches.

The tape also includes a layer 22 of grit material 24 fixed on upper surface 18, typically by a binder material 26 that has been spread over surface 20. Grit material 24 may be further fixed in place by an adhesive layer 28 (shown partially cutaway in FIG. 1) spread over the grit material. Layer 22 may be formed in any manner suitable for creating an upper surface on tape 10 that improves the tape's traction. Thus, it may include grit material 24 or may be formed in other ways, such as by striating or otherwise roughening an upper surface of the tape.

Typically grit material 24 includes one or more of crushed glass particles, silicon carbide, or aluminum oxide or other suitable mineral-based or other type of grit material. Typically the grit material is screened or otherwise selected to a mesh size of between about 60 and about 100. Preferably a hard material, such as silicon carbide is used, although materials having a greater or lesser hardness and greater or lesser mesh size may be selected, depending on the desired performance characteristics for the tape's expected application. Typically the grit material or other friction-enhancing feature of the tape extends substantially over the entire upper surface of film sheet 12, but alternatively the friction-enhancing may cover only a portion of the upper surface and may be arranged in any shape or pattern.

The tape also includes an adhesive layer 30 coated or otherwise affixed on lower surface 20 of film sheet 12. Layer 30 is preferably a pressure-sensitive adhesive but alternatively may be a moisture activated or other type of adhesive. Furthermore, adhesive layer 30 may be left off of tape 10, and the tape attached to a substrate by application of an adhesive at the time of use to either the tape of the substrate, or by other means of affixing the tape to the substrate. Typically, adhesive layer 30 covers substantially the entire lower surface 20 of sheet 12, but alternatively may cover only a portion depending on the desired characteristic of the tape.

As shown in FIG. 1, a removable release paper 32 may cover adhesive layer 30, particularly in the case of a pressure-sensitive adhesive, to prevent adherence of the tape to itself or other objects prior to application to the substrate. Release paper 32 typically includes a silicone coating, or other non-stick substance, on the side facing the adhesive to allow paper 32 to be readily removed from the adhesive.

Film sheet 12 is preferably provided in a planar, uniform, continuous sheet, and grit layer 22 and adhesive layer 30 are fixed on the opposing surfaces of film sheet 12 also in a planar, uniform, continuous manner, although other constructions may alternatively be used. Tape 10 thus preferably is initially provided in a planar, uniform, continuous format, and then is processed to add a plurality of perforations, such as pinholes 34 (See FIGS. 1, 2, 5, and 6). Typically pinholes 34 extend through all of grit layer 22, film sheet 12, and adhesive layer 30 and are distributed over the tape in a regular pattern, such as staggered rows 36, as best seen in FIG. 2. Alternatively, the pinholes may be distributed irregularly, or in any appropriate pattern as may be desired for a particular application or suited to a particular manufacturing method. Preferably the pinholes have at least about 0.2-inches of spacing between adjacent pinholes, and typically are placed in staggered rows with about 0.4-inches between each row and 0.4-inches between each pinhole along each row, but other spacing may be used.

Pinholes 34 are typically circular, as viewed from above in FIG. 2, to provide a cross-sectional area allowing the passage of air therethrough, and have a diameter of between about 0.007-inches and about 0.025-inches, although other sizes and shapes may be used. Pinholes 34 may be cylindrical in construction, or conical, as shown in FIG. 1, or other shapes, depending on the method for construction. The conical shape of FIG. 1 is typical of a pinhole created with a conical pin, but other pin shapes, including cylindrical may be used.

Pinholes 34 typically are of a uniform size and shape, but may be produced in varying shapes and sizes. In any case of size, shape, and distribution, the pinholes will define a cumulative area, i.e., the sum of the cross-sectional areas of the pinholes, for the area of the sheet surface over which the pinholes are distributed. Typically the cumulative area of the pinholes is between about 0.04% and about 1.0% of the sheet surface area over which the pinholes are distributed. The pinholes are preferably sized, shaped, and distributed to provide sheet 12 with sufficient fluid passage therethrough to substantially prevent the entrapping of air bubbles between the tape and the substrate as the tape is lowered onto and adhered to the substrate.

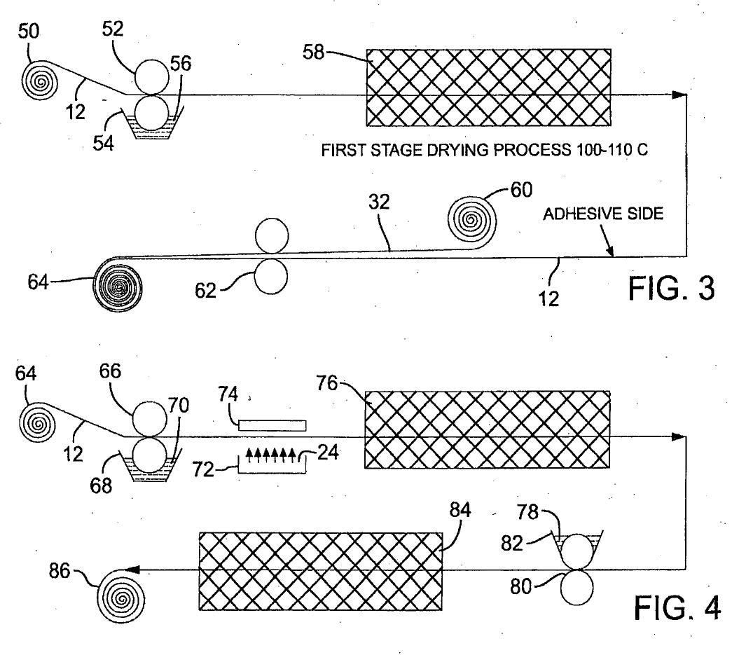

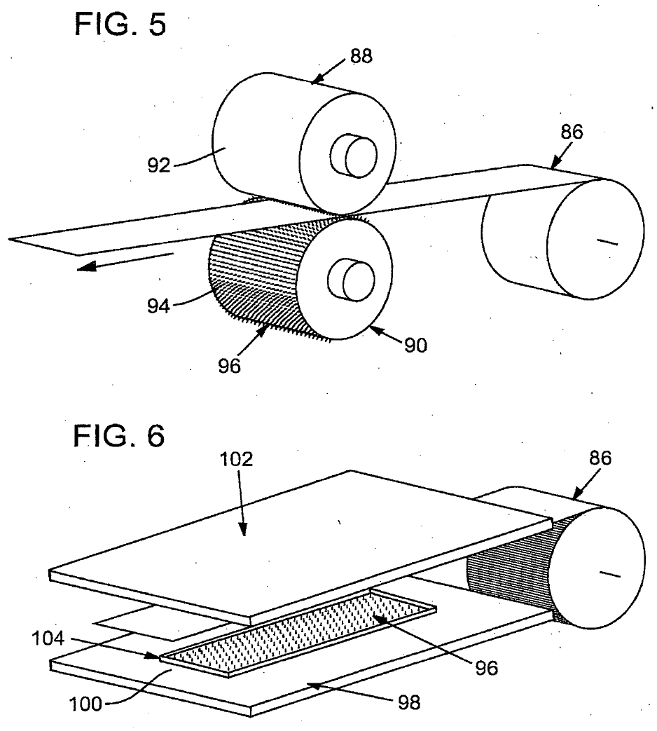

A method for making an embodiment of the grip tape is shown in FIGS. 3 and 4. As shown, film sheet 12, adhesive layer 30 and release paper 32 are assembled in FIG. 3; grit layer 22 is added in FIG. 4; and the tape is perforated in FIGS. 5 and 6.

As illustrated in FIG. 3, a roll 50 of film sheet 12 is fed through a pair of opposed rollers 52, the lower of which is partially submerged in a tub 54 of a liquid adhesive 56. Lower surface 20 of film sheet 12 is coated with adhesive 56 as the sheet passes through the rollers. Adhesive 56 may then be cured on film sheet 12, for example by drying the adhesive in an environment 58 preferably heated to between about 100° C. and about 110° C. Other methods may be used to apply the adhesive to the tape, which may or may not make use of the curing step.

A roll 60 of release paper 32 may be applied over the adhesive side of film sheet 12 and typically is pressed onto the adhesive by a pass through a pair of pinch rollers 62. The assembled film sheet 12, adhesive layer 30, and release paper 32 may be rolled up in a roll 64. The pinch rollers provide sufficient adherence of the release paper to the adhesive so that it remains in place during subsequent processing and shipping of the tape, until the user is ready to apply the tape to the substrate. Other methods may be used of applying the release paper.

As illustrated in FIG. 4, roll 64 of the assembled film sheet 12, adhesive layer 30 and release paper 32 may be further provided with grit layer 22 by being fed through a pair of opposed rollers 66. The lower of rollers 66 may be partially submerged in a tub 68 of a binder 70, such as a liquid acrylic adhesive, thus coating upper surface 18 (on the underside of film sheet 12 as seen in FIG. 4) of film sheet 12 with a layer of the binder.

Grit 24 may then be applied to the film sheet, for example by an electrostatic application wherein the film sheet passes in close proximity over a tray or other carrier 72 of grit 24 and static electricity produced by an electrode 74 or other device causes the grit pieces to be driven upwards and embedded in the layer of binder 70. Typically at this point most pieces of grit are partially embedded in binder 70, which is still wet, and a portion of each grit piece protrudes out of the binder. The binder may then be at least partially cured on film sheet 12, for example by drying the binder in an environment 76 preferably heated to between about 100° C. and about 110° C. Other methods may be used to apply the binder and grit to the tape, which may or may not make use of the curing step.

The grit pieces and binder on film sheet 12 may be overlaid with a coating of an adhesive 78 by passing the film sheet through a pair of opposed rollers 80. The upper one of rollers 80 preferably draws adhesive 78 from a tub 82 and applies it over the grit pieces and binder on upper surface 18 of film sheet 12. Adhesive 78 may then be cured on film sheet 12, for example by drying the adhesive in an environment 84 preferably heated to between about 100° C. and about 110° C. Other methods may be used to apply adhesive 78 to the tape, which may or may not make use of the curing step. The assembled tape may then be rolled up in a roll 86 for further processing.

As shown in FIG. 5, roll 86 of the assembled film, adhesive layer, and grit layer may be perforated with the distributed plurality of pinholes 34 by being fed through a pair of opposed rollers, such as first roller 88 and second roller 90. Roller 88 preferably provides a smooth, cylindrical outer surface 92, preferably made of a an elastomeric material, such as polyurethane. A suitable material is Durathane® with a hardness between about 50 Shore A scale and about 65 Shore D, and most preferably about 90 Shore A. Roller 90 may have an outer cylindrical surface 94 on which are disposed a plurality of pinhole-making structures, such as pins 96. The pins may be distributed over the cylindrical surface in a pattern which is desired to be applied to the tape, for example parallel rows of staggered holes. As the tape is fed through the rollers, the rollers are pressed together with sufficient force for pins 96 to perforate the tape with the distributed pinholes 34.

Another method of perforating the tape is shown in FIG. 6, where the tape is fed between a board 98 that has a plurality of pinhole-making structures, such as pins 96 distributed over a surface 100 of the board. The tape is laid over the board, typically sequentially in sections, and each section is perforated, for example, by pressing a plate 102 disposed over the board down onto the tape, thus causing pins 96 to perforate the tape with a distributed plurality of pinholes 34. Board 98 may also include a die, such as rectangular die 104 for cutting the roll of tape into sections of any desired size and shape, preferably simultaneously with the perforating. Other methods of creating the pinholes or other perforations in the tape may be used or the above described methods may be modified as desired for a particular application.

The subject matter described herein includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements. It is believed that the following claims particularly point out certain combinations and subcombinations that are directed to one of the disclosed embodiments and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the present disclosure.

1. A grip tape for application to a substrate without substantially entrapping air bubbles between the tape and the substrate, the tape comprising:
a sheet of film, the sheet defining a first surface and a second surface opposite to and coextensive with the first surface, the surfaces having a width and a length defining an area;
a layer of grit material fixed on the first surface of the sheet; and
an adhesive layer on the second surface of the sheet,
wherein the adhesive layer, grit layer, and sheet include a plurality of perforations extending therethrough, the plurality of perforations distributed over the area of the sheet surfaces, each perforation defining a cross-sectional area, the plurality of perforation areas defining a cumulative area that is no more than about 1% of the sheet surface area over which the perforations are distributed.

2. The grip tape of claim 1 wherein the film sheet is substantially comprised of a thermoplastic material.

3. The grip tape of claim 1 wherein the film sheet includes two plies.

4. The grip tape of claim 1 wherein the layer of grit material substantially covers the first surface of the sheet.

5. The grip tape of claim 1 wherein the layer of adhesive substantially covers the second surface of the sheet.

6. The grip tape of claim 1 further comprising a release paper disposed over the adhesive layer.

7. The grip tape of claim 6 wherein the release paper includes a silicone coating.

8. The grip tape of claim 1 wherein the grit material is selected from the group of crushed glass particles, silicon carbide, and aluminum oxide.

9. The grip tape of claim 1 wherein the cumulative area of the perforations is at least about 0.04% of the sheet surface area.

10. The grip tape of claim 1 wherein the perforations are distributed in a substantially regular pattern.

11. The grip tape of claim 1 wherein the sheet width is at least about 9-inches.

12. A grip tape for application to a substrate without substantially entrapping air bubbles between the tape and the substrate, the tape comprising:
a sheet of film, the sheet defining a first surface and a second surface opposite to and coextensive with the first surface;
a layer of grit material adhered to the first surface of the sheet;
an adhesive layer coated on the second surface of the sheet,
wherein the adhesive layer, grit layer, and sheet include a plurality of pinholes extending therethrough, the plurality of pinholes providing the sheet with sufficient fluid passage therethrough to substantially prevent the entrapping of air bubbles between the tape and the substrate.

13. The grip tape of claim 12 wherein at least a portion of the pinholes have a diameter of between about 0.007-inches and about 0.025-inches.

14. The grip tape of claim 12 wherein the film sheet includes two plies.

15. The grip tape of claim 12 further comprising a release paper disposed over the adhesive layer.

16. The grip tape of claim 12 wherein the grit material is selected from the group of crushed glass particles, silicon carbide, and aluminum oxide.

17. The grip tape of claim 12 wherein the pinholes are distributed in a substantially regular pattern.

18. The grip tape of claim 12 wherein the tape is provided in a roll having a width, and wherein the width is at least about 9-inches.

19. A grip tape for application to a substrate without substantially entrapping air bubbles between the tape and the substrate, the tape comprising:
a sheet of film, the sheet defining a first surface and a second surface opposite to and coextensive with the first surface, the surfaces having a width and a length defining an area;
a layer of grit material adhered to the first surface of the sheet;
an adhesive layer coated on the second surface of the sheet;
and a plurality of pinholes distributed over the area of the sheet surfaces, the plurality of pinholes having a spacing and each pinhole having a diameter to provide the sheet with sufficient fluid passage therethrough to substantially prevent the entrapping of air bubbles between the tape and the substrate.

20. The grip tape of claim 19 wherein at least a portion of the pinholes have a diameter of between about 0.007-inches and about 0.025-inches.

21. The grip tape of claim 19 wherein the film sheet includes two plies.

22. The grip tape of claim 19 wherein the spacing between adjacent pinholes is no less than about 0.2-inches.

23. The grip tape of claim 19 wherein the pinholes are distributed in a substantially regular pattern.

24. The grip tape of claim 19 wherein the sheet width is at least about 9-inches.

25. A method for making a perforated grip tape for application to a substrate substantially without forming air bubbles between the tape and the substrate, the method comprising:
providing a length of film having a first surface and a second surface and a width;
applying an adhesive layer to the first surface of the film;
applying a layer of grit to the second surface of the film;
perforating the film, adhesive layer, and grit layer with a plurality of pinholes distributed over the length and width of the film, the pinholes sized and spaced apart to provide sufficient fluid passage therethrough to substantially prevent air bubbles from forming between the tape and the substrate.

26. The method of claim 25 wherein the film is a two-plied film.

27. The method of claim 25 further comprising a step of curing the adhesive on the film.

28. The method of claim 25 further comprising a step of applying a release paper to the adhesive.

29. The method of claim 25 further comprising a step of applying a binder to the second surface of the film to attach the grit layer to the film.

30. The method of claim 29 further comprising a step of at least partially curing the binder on the film.

31. The method of claim 19 further comprising a step of applying an adhesive over the grit layer.

32. The method of claim 31 further comprising a step of curing the adhesive over the grit layer.

33. The method of claim 25 wherein the step of applying the grit layer includes an electrostatic application of the grit.

34. The method of claim 25 wherein the pinholes are distributed in a regular pattern of staggered rows.

35. The method of claim 25 wherein the pinholes are distributed over an area of the tape, and the pinholes provide an area for fluid passage therethrough which is between about 0.04% and about 1.0% of the tape area over which the pinholes are distributed.

36. The method of claim 25 wherein the step of perforating the film includes a step of providing a first roller with an outer cylindrical surface, the roller having a plurality of pinhole-making structures distributed over the cylindrical surface, and a step of rolling the tape over the first roller to perforate the tape with the pinholes.

37. The method of claim 36 further comprising a step of providing a second roller with an outer cylindrical surface opposed to the surface of the first roller for rolling the tape therebetween to perforate the tape with the pinholes.

38. The method of claim 37 wherein the surface of the second roller substantially comprises a material having a hardness between about 50 Shore A scale and about 65 Shore D.

39. The method of claim 25 wherein the step of perforating the film includes a step of providing a board having a plurality of pinhole-making structures distributed over a surface of the board, and a step of laying the tape over the board to perforate the tape with the pinholes.

40. The method of claim 39 further comprising a step of providing a plate disposed over the board for pressing the tape onto the pinhole-making structures.

41. The method of claim 25 wherein the width of the film is at least about 9-inches.
